(19) United States
(12) Patent Application Publication
(10) Pub. No.: US 2005/0144745 A1
(43) Pub. Date: Jul. 7, 2005

(54) Toothbrush

(76) Inventor: Bruce M. Russell, Howell, NJ (US)

Correspondence Address: COLGATE-PALMOLIVE COMPANY, 909 RIVER ROAD, PISCATAWAY, NJ, 08855, US

(21) Appl. No.: 10/753,899

(22) Filed: Jan. 7, 2004

(51) Int. Cl. A61C 17/26

(52) U.S. Cl. 15/23

(57) ABSTRACT

A toothbrush includes an elongated shaft rotatably mounted to the cleaning surface of the brush head parallel to the longitudinal axis of the brush head. Cleaning elements are mounted to and extend outwardly from the shaft. In one embodiment of the invention the cleaning elements are disposed at an angle which is non-perpendicular to the shaft. In another embodiment of the invention the shaft and cleaning elements are in the form of a roller wherein the cleaning elements extend continuously along the length of the shaft.

### BACKGROUND OF THE INVENTION

There has been a longstanding effort in the art to provide improved toothbrushes. U.S. Pat. No. 6,477,729 discloses a toothbrush wherein the brush head includes a plurality of rotatable brush assemblies mechanically linked together so as to move with the handle. Each rotatable assembly includes a wheel with radially projecting bristles. The bristles are arranged on rotatable wheels in such a manner that the bristles or tufts are positioned at an angle relative to the longitudinal axis of the brush. In a practice of this invention the tufts of bristles are mounted in two parallel rows with the bristles angled as mirror images or each other.

Other bristle arrangements for toothbrushes are described in U.S. Pat. Nos. 1,351,159, 1,643,217, 2,691,182, 6,389,634 and 6,453,497. Reference is also made to U.S. Pat. No. 4,438,601, German Patentschrift 63528 and French Patent No. 1147667 for other devices having rotatable heads.

### SUMMARY OF THE INVENTION

An object of this invention is to provide a toothbrush having more complete coverage of tooth surfaces including the gum line and the hard to clean between teeth areas.

A further object of this invention is to provide such a toothbrush having manufacturing efficiencies.

In accordance with one practice of this invention at least one elongated shaft is rotatably mounted to the cleaning surface of the toothbrush head parallel to the longitudinal axis of the head. The shaft extends over a major portion of the length of the head. A plurality of cleaning elements is mounted to the shaft and extends outwardly from the shaft. The cleaning elements are disposed at an angle which is non-perpendicular to the shaft.

The shaft and its cleaning elements may, in combination, be in the form of a roller (similar to a snow sweeper) where the cleaning elements extend generally continuously over the major portion of the shaft. The cleaning elements could be disposed at any desired angle to the shaft, including being perpendicular.

In a further practice of this invention the head may be in the form of an open frame which would provide a more hygienic brush since water and residue would not accumulate in the head. If desired a shield may be secured across the frame on its side opposite the cleaning side. The shield would have a plurality of openings or in itself would be of generally open form to protect sensitive cheek tissue from being touched by the cleaning elements. In addition, the openness of the shield would still result in the hygienic toothbrush.

The invention may be practiced where the toothbrush is a manual toothbrush and the shaft is freely rotatable in a set of bearings at each end of the head. The shaft may be permanently or detachably mounted to the bearings.

Alternatively, the invention may be practiced where the toothbrush is a power toothbrush wherein a drive mechanism in the handle of the toothbrush drives the shaft carrying the cleaning elements.

In either the manual or the power form of toothbrush the invention may be practiced where there is more than one shaft, such as two parallel shafts. In such case, the cleaning elements could be mirror images of each other at the same angle or could be at the same angle but in the same direction. Alternatively, the cleaning elements on one shaft could be disposed in generally the same direction as on the other shaft but at a different angle or could be disposed in an opposite direction of the cleaning elements on the other shaft, but at a different angle.

The shaft itself may take various forms such as being a twisted wire or being molded wherein the cleaning elements are soft spikes integral with the core which itself forms the shaft. The cleaning elements could be fiber bristles or could be elastomeric elements such as elastomeric cleaning pads.

### THE DRAWINGS

FIG. 1 is a front elevational view of a toothbrush in accordance with one embodiment of this invention;

FIG. 2 is a front elevational view of a portion of a toothbrush in accordance with a further embodiment of this invention;

FIGS. 3-4 are front elevational views of a portion of a toothbrush in accordance with further practices of this invention;

FIG. 5 is a cross-sectional view taken through FIG. 1 along the line 5-5;

FIG. 6 is a cross-sectional view taken through FIG. 2 along the line 6-6-;

FIG. 7 is a cross-sectional view taken through FIG. 2 along the line 7-7;

FIGS. 8-9 are cross-sectional views of further variations of this invention;

FIG. 10 is an end elevational view of a toothbrush showing a shaft mounted in a bearing; and

FIG. 11 is a rear elevational view of a further toothbrush in accordance with this invention.

### DETAILED DESCRIPTION

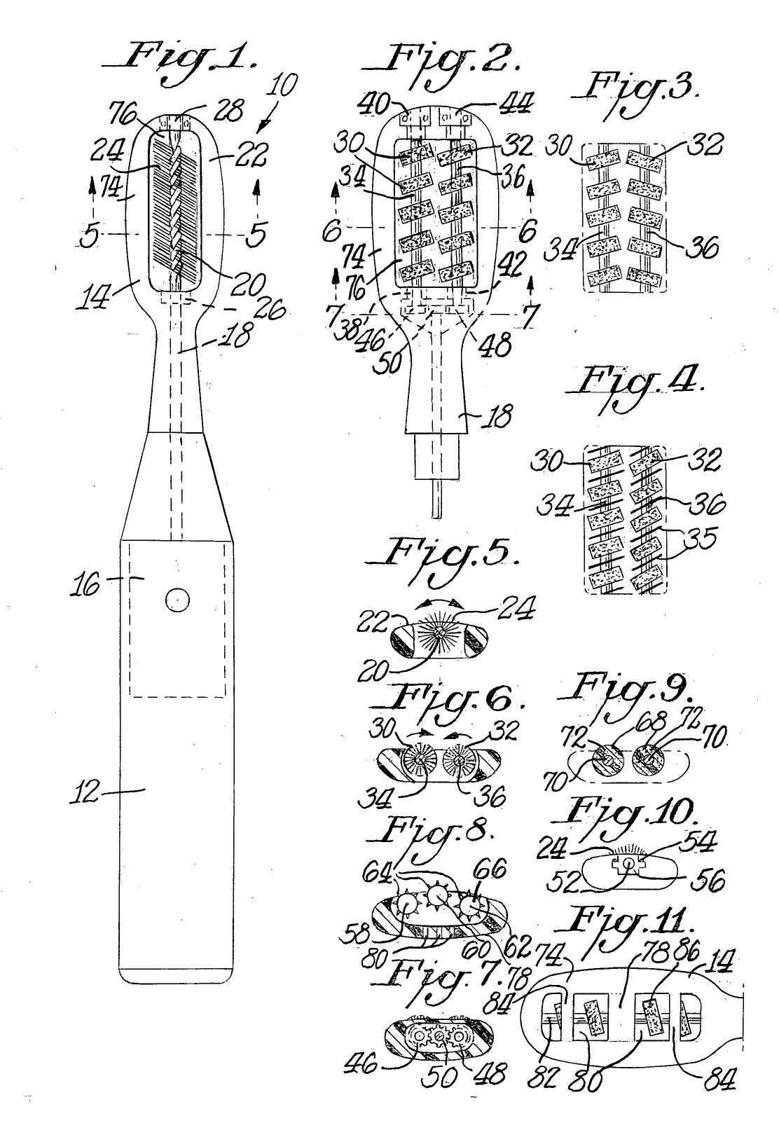

FIG. 1 illustrates a toothbrush 10 in accordance with this invention. As shown therein toothbrush 10 includes a handle 12 and a cleaning head 14. In the embodiment illustrated in FIG. 1 the toothbrush is a power driven toothbrush wherein the handle 12 would include a motor 16 and batteries (not shown). Motor 16 has a drive shaft 18 which rotatably drives cleaning shaft 20. Cleaning shaft 20 is located at the cleaning side or surface 22 of head 14. A plurality of cleaning elements 24 which are illustrated in FIGS. 1 and 5 as being fiber bristles are secured to shaft 20 over a major portion of the length of head 14. Preferably the bristles extend at least ⅓ of the length of head 14 and more preferably at least ½ of the length and most preferably at least ⅔ or at least about 90% of the length of head 14.

Shaft 20 as illustrated in FIG. 1 is made from the known twisted wire process to result in a rotatable shaft of, for example, nylon wire. In this twisted wire process a wire is bent upon itself. Bristles are inserted between the bent portions. The wire is then twisted upon itself to lock the bristles in place with the bristles 24 extending outwardly from the shaft 20.

The density or number of bristles along different portions of shaft 20 may be varied by controlling the number of bristles at any given portion or by controlling the degree of spiraling of the twisted wire. The greater degree of spiraling would tend to pull the bristles closer together.

Preferably, the bristles are disposed at an angle between 10-45° in relationship to the wire core shaft 20. Shaft 20 is mounted to head 14 by being inserted into bearings 26,28 at each end of head 14. The bearings permit the shaft 20 to thereby rotate. Where toothbrush 10 is a manual toothbrush, shaft 20 is freely rotatable in the bearings 26,28. Alternatively, toothbrush 10 can be a powered toothbrush wherein shaft 20 would be connected either directly or through gearing to drive shaft 18 so that the rotation of shaft 20 is thereby controlled by drive shaft 18. As a result, the rotation could be a back and forth oscillation or could be a one-way 360° continuous rotation.

FIG. 1 illustrates brush head 14 to include a single centrally located shaft having a continuous set of bristles creating a generally roller structure. The invention may also be practiced where the single shaft is of a cylindrical or other type shape with the bristles being in the form of tufts mounted as individual wheels uniformly spaced from each other uniformly or spaced by some variable distance relationship with respect to each other. As previously discussed U.S. Pat. No. 6,477,729 discloses a brush in which rotatable wheels of toothbrush bristles or tufts are positioned in a toothbrush head at an angle relative to the longitudinal axis of the brush. Although this may deliver benefits to the user, if the row of wheels were connected to a central shaft (as in accordance with this invention) a continuous string of bristles could be produced providing more complete coverage of tooth surfaces including the gum line and the hard to clean between teeth areas. In addition, this practice of the invention would provide manufacturing efficiencies. For example, instead of assembling ten wheels into a toothbrush head, two shafts with the equivalent of five wheels each could be assembled. (See FIGS. 2-4) Such arrangement would have economic benefits.

The axels of rotatable bristles could be formed in a number of ways. FIG. 1 illustrates the use of a twisted wire to form the axel or shaft. The bristles or tufts, however, could be fastened into a cylindrical core of plastic by either conventional stapling or nonstapling brush manufacturing processes. FIG. 2 illustrate a practice of the invention wherein the cleaning elements are tufts of bristles formed as parts of individual wheels 30,32. The wheels 30,32 are arranged on two parallel shafts 34,36. The wheels 30,32 extend over a major length of the head 14. Shaft 34 is mounted in bearings 38,40 while shaft 36 is mounted in bearings 42,44. If the toothbrush is a manual toothbrush the shafts 34,36 would freely rotate in the bearings. Where, however, the toothbrush is a power toothbrush, as illustrated in FIG. 2, each shaft would be associated with a gear 46,48 which meshes with and is driven by intermediate gear 50. Drive gear 50 is driven by shaft 18. See FIGS. 2 and 7.

In accordance with one aspect of this invention the cleaning elements and wheels are mounted on each respective shaft at an angle which is non-perpendicular to the shaft. The exact angular arrangement may vary in accordance with the invention. FIG. 2, for example, illustrates the wheels 30,32 to be inclined in the same direction and at the same angle with each other. Wheels 30,32 are interdigitated with respect to each other. FIG. 3 shows the wheels 30,32 to be mirror images of each other inclined at the same angle to their shafts 34,36. FIG. 4 shows a further variation where the wheels 30 on shaft 32 are inclined at a different angle than the wheels 32 on shaft 36. FIG. 4 illustrates the wheels 30,32 to be inclined in generally the same direction as in FIG. 2. The provision of different angles for the wheels 30,32 may also be used where the wheels are generally mirror images of each other as in FIG. 3. A further variation is to have the cleaning elements on one set of wheels 30 differ in length from the cleaning elements on the other set of wheels 32. Alternatively, the wheels of individual sets on the same shaft may have its cleaning elements differ in length from the cleaning elements on other wheels mounted on the same shaft.

As previously noted the shaft and cleaning element combination could be made in a number of ways. FIG. 1, for example, illustrates the twisted wire embodiment. In another variation the bristles or tufts could be fastened into a cylindrical core of plastic by either conventional stapling or non-stapling brush manufacturing processes. It is also possible to injection mold the rotatable shafts of cleaning elements. For example, standard thermoplastics and thermoplastic elastomers can be used either individually or in combination. Thus, it would be possible to mold a shaft of polypropylene having very thin and relatively long extensions (bristle elements) of polypropylene coming from the core. In another embodiment the shaft could be polypropylene but the bristle extensions might be molded from a thermoplastic elastomer. See FIG. 8.

The invention may be practiced where the wheels 30,32 have outwardly extending cleaning elements such as bristles or elastomeric fingers. FIG. 4 illustrates a variation where cleaning elements 35 extending directly from the shaft 34 or 36 are located between adjacent wheels 30 or 32. In such cases the wheels 30 and/or 32 can have their own cleaning elements or can function as guides for the cleaning elements 35 without having their own cleaning elements. When functioning as guides wheels 30 and/or 32 could be fairly thin and may even be pointed. The wheels and cleaning elements are preferably disposed parallel to each other.

The shafts or axels of rotatable cleaning elements such as bristles can be fastened into molded bearings, such as bearings 26,28 which could be part of the brush head or brush frame as later described. Different methods exist for securing the shafts into the bearings. The shafts could be fit directly into a locking mechanism on a permanent drive shaft such that the shafts could be replaced after extended wear of the cleaning elements. FIG. 10 illustrates a detachable mounting wherein the shaft 52 has a detent 54 which snaps into the bearing 56 so that the shaft is firmly held in place during use but the shaft 52 can be removed and replaced by a different similar shaft having fresh or different types of cleaning elements.

One aspect of this invention is to form the shaft and cleaning elements as a roller in a manner similar to powered snow sweepers. It is known in current powered toothbrush which utilize vibratory action, ultrasonics and most commonly an oscillatory motion of a bristle head that moves back and forth at fixed degrees of motion around a fixed point in the middle of the brush head. In current toothbrushes the brush head rotates, for example, in one plane 200 in each direction around an axis that would be perpendicular to the brush head or handle. With the embodiment of the invention using a roller, the bristles or other cleaning elements would be movable about a rotating axis that is parallel to the longitudinal axis of the brush head or brush handle. As noted, this would be similar to the action of a powered snow sweeper, but done on a very miniaturized scale. Such brushes in accordance with this aspect of the invention would also be similar to brushes in car washes. FIG. 1 illustrates such a brush wherein the bristles extend continuously along the length of the axis so as to be in more of a roller structure rather than being arranged in discreet spaced segments as on the wheels shown on FIGS. 2-4. These powered brushes could have the rollers make a complete 360° rotation about its axis or an oscillatory motion with any desired degree of rotation. The cleaning elements on the roller could be installed at virtually any angle relative to the rotating core of the roller. In the preferred practice of the invention the angle is non-perpendicular to the roller axis, but the angle could also be perpendicular. The rollers could be constructed in various manners. One example is the twisted wire brush arrangement shown in FIG. 1 where the rollers include a shaft that could be directly driven or driven through a gear transmission. The rollers could be injection molded thermoplastic or thermoplastic elastomers that have relatively small soft spikes coming from the central core or central shaft as illustrated in FIG. 8 which shows three rollers 58,60,62 having soft spikes 64 extending from the central core 66 of each roller.

Where the cleaning elements are molded, the cleaning elements could be integral with a wheel or core formed by injection molding. For example, the cleaning elements could be spikes extending from a wheel where both the wheel and spikes are made of the same elastomer. Alternatively, the wheel could be made of a hard elastomer and the spikes could be made from a different softer elastomer. In yet another variation the wheel itself could be the cleaning element without the inclusion of added spikes or other cleaning elements. Such wheel may be a flat elastomeric wall which may or may not be pointed or tapered. The walls could be formed to function as massage elements.

In a further embodiment such as is illustrated in FIG. 9 the rollers 68 could have a central shaft 70 in which soft pads of material such as elastomeric pads 72 are attached to the central core or shaft 70 in any number of methods. This roller brush 68 would be more like the car wash type. Other manners of attaching the cleaning pads 72 could include adhesive, heat staking, riveting, etc.

In the embodiment of the invention using roller type brush members the cleaning elements, whether in the form of fiber bristles, elastomeric extensions or pads, could be very flexible and thus loosely extending from the shaft rather than extending straight outwardly. Such flexible type cleaning elements would be similar to a car wash type. Alternatively the cleaning elements could have some degree of stiffness so as to be shape retaining more along the line of snow sweepers.

Brushes made in the form of rollers could be a single roller such as FIG. 1 that could have relatively small, thereby increasing maneuverability inside the oral cavity or could be made with multiple rollers. For example, there could be two rollers with counter rotating movements wherein one movement is clockwise and the other counterclockwise. This would be similar to what is shown in FIG. 6 and in FIG. 2 except that the cleaning elements would not be spaced wheels, but rather each shaft would be in the form of a roller wherein the cleaning elements extend continuously generally the entire length of the shaft without such discreet spacing as with the wheels shown in FIG. 2. In another embodiment, such as illustrated in FIG. 8 there could be three rollers 58,60,62 in which the rollers are either in the same plane or in three different planes or in which two rollers are in one plane which differs from the plane of the third roller. Any combination of direction of rotation or oscillation could be used, although some combinations would be more difficult to accomplish than others. A single roller brush may have advantages of requiring less power due to direct drive and fewer energy losses in the transmission that would also allow a smaller powered brush to be made.

Various features described above with respect to rollers could also be applied where the cleaning elements are in the form of spaced wheels.

The rollers or wheels or other forms of cleaning elements mounted on shafts could be mounted on a solid type conventional brush head. In accordance with a further aspect of this invention the brush head is made in an open manner by being a frame member 74 having a significant open space 76 such as illustrated in FIGS. 1 and 2. Thus, as shown the brush head 14 is in the form of a generally oval shaped ring extending from the handle 12 wherein the longitudinal ends of the ring provide a surface on which the bearings could be mounted so that the shafts and their cleaning elements could be secured across the open space. This provides for a more hygienic brush since water and residue is not allowed to accumulate in the brush head.

Where an open frame is used as the brush head, it would be desirable to provide some protection to prevent the cleaning elements from contacting the sensitive cheek tissue. FIGS. 1-2 show the cleaning elements extending outwardly from the cleaning or front face 22 of the head 14. FIGS. 8 and 11 show the provision of a shield 78 on the rear face of the head 14. The shield could take any suitable form. What is important is that some structure is provided between the rotating cleaning elements and the cheek tissue to prevent the cleaning elements from touching the cheek tissue. Such structure, however, should not defeat the purpose of having an open frame which prevents water and residue from accumulating. Thus, the shield structure should be provided with sufficient openings 80 as shown in FIGS. 8 and 11 which would permit water and residue to pass through the toothbrush head. FIG. 11 shows the shield to be in skeletal form having a plurality of cross members 84 extending across the rear surface of the open frame 74 outwardly of shaft 82 having cleaning wheels 86.

In one aspect of the invention the cleaning elements are mounted on a shaft which is parallel to the longitudinal axis of the brush head but wherein the cleaning elements extend outwardly from their shaft at an angle which is non-perpendicular to the shaft. Various types of cleaning elements may be used in accordance with this invention. The invention can be practiced with combinations of the same or different cleaning element configurations (such as stapled or in-molded technology bristles, anchor free tufting, etc.) and/or with the same bristle or cleaning element materials (such as nylon bristles, spiral bristles, rubber bristles, etc) The bristles could be thin fiber bristles or could also be made of elastomeric materials having various shapes such as flat walls. Accordingly the term “cleaning elements” is intended to be used in its broadest sense. The term “roller” is intended to mean a shaft having a continuous arrangement of cleaning elements extending outwardly from the shaft along the major length of the shaft similar to snow sweepers.

1. A toothbrush comprising a handle, a head connected to said handle, said head having a longitudinal axis and a cleaning surface, at least one elongated shaft rotatably mounted to said cleaning surface parallel to said longitudinal axis, said shaft extending over a major portion of the length of said head, a plurality of cleaning elements mounted to and extending outwardly from said shaft, and said cleaning elements being disposed at an angle which is non-perpendicular to said shaft.

2. The toothbrush of claim 1 wherein said head is in the form of an open frame having a centrally located open area, and said cleaning elements being located at said open area.

3. The toothbrush of claim 2 wherein said head has a back side opposite said cleaning surface, a shield being mounted to said back side across said open area outwardly beyond said cleaning elements, and said shield being of open construction to permit water and residue to flow through said shield.

4. The toothbrush of claim 2 wherein said shaft and said cleaning elements are in the form of a roller having said cleaning elements located continuously along the length of said shaft.

5. The toothbrush of claim 1 wherein said shaft is detachably mounted in bearings secured to said cleaning surface of said head.

6. The toothbrush of claim 1 wherein said shaft is in the form of a bent wire spirally wound around itself, and said cleaning elements being fiber bristles extending through said bent wire.

7. The toothbrush of claim 6 wherein said cleaning elements are arranged along the length of said wire in a non-uniform density.

8. The toothbrush of claim 1 wherein said cleaning elements are arranged as sets of spaced wheels along said shaft.

9. The toothbrush of claim 1 wherein there are two of said shafts disposed parallel to each other with each of said shafts having said cleaning elements mounted thereon.

10. The toothbrush of claim 9 wherein said cleaning elements of one of said shafts are disposed at an angle which is the mirror image of said cleaning elements on the other of said shafts and with said angle being the same for said cleaning elements on both of said shafts.

11. The toothbrush of claim 9 wherein said cleaning elements are disposed at generally the same angle in generally the same direction as each other.

12. The toothbrush of claim 9 wherein said cleaning elements on said shafts are disposed in generally the same direction and at different angles from each other.

13. The toothbrush of claim 9 wherein said cleaning elements on said shafts are disposed in generally opposite directions at different angles from each other.

14. The toothbrush of claim 9 wherein said cleaning elements on one of said shafts are of a different length than said cleaning elements on the other of said shafts.

15. The toothbrush of claim 9 wherein said shaft is power driven by a power drive in said handle.

16. The toothbrush of claim 15 wherein said shafts rotate in opposite directions to each other.

17. The toothbrush of claim 15 including a third rotatably mounted shaft mounted to said cleaning surface parallel to said two shafts.

18. The toothbrush of claim 9 wherein said cleaning elements are in the form of sets of wheels spaced from each other along the length of said shafts.

19. The toothbrush of claim 9 wherein each of said shafts and its said cleaning elements is in the form of a roller having said cleaning elements mounted continuously along the length of said shaft, and said cleaning elements being bristles.

20. The toothbrush of claim 19 wherein said cleaning elements are arranged along the length of said shaft in a non-uniform density.

21. The toothbrush of claim 9 wherein said cleaning elements on said shafts is a different type than said cleaning elements on the other of said shafts.

22. The toothbrush of claim 21 wherein said cleaning elements on one of said shafts is in the form of fiber bristles, and said cleaning elements are on the other of said shafts being in the form of elastomeric walls or fingers.

23. The toothbrush of claim 1 wherein said shaft and said cleaning elements is in the form of a roller having said cleaning elements disposed continuously along the length of said roller, and said cleaning elements being bristles.

24. The toothbrush of claim 1 wherein said solid shaft is a cylindrical core and said cleaning elements are spikes extending outwardly from said core.

25. The toothbrush of claim 1 wherein said cleaning elements are elastomeric pads.

26. The toothbrush of claim 1 wherein a plurality of wheels are mounted to said shaft parallel to said cleaning elements, and each set of said cleaning elements being located between a pair of adjacent wheels.

27. The toothbrush of claim 1 wherein said cleaning elements are sets of cleaning elements mounted to and extending outwardly of sets of wheels mounted on said shaft.

28. The toothbrush of claim 27 wherein each set of said cleaning elements is spikes molded integral with a respective one of said wheels and made from the same elastomeric material.

29. The toothbrush of claim 27 wherein each set of said cleaning elements is spikes molded to its respective wheel, and said spikes being made from an elastomer material which is softer than the elastomer material of said wheels.

30. The toothbrush of claim 1 wherein said toothbrush is a manual toothbrush.

31. The toothbrush of claim 1 wherein said toothbrush is a power toothbrush.

32. A toothbrush comprising a handle, the head connected to said handle, said head having a longitudinal axis and a cleaning surface, at least one elongated shaft rotatably mounted to said cleaning surface parallel to said longitudinal axis, said shaft extending over a major portion of the length of said head, a plurality of cleaning elements mounted to and extending outwardly from said shaft, said head being in the form of an open frame having a central open area, said shaft being mounted longitudinally across said frame with said cleaning elements disposed at said open area, and said cleaning elements and said shaft comprising a roller wherein said cleaning elements extend continuously across a major portion of the length of said shaft.

33. The toothbrush of claim 32 wherein said shaft is in the form of a bent wire, and said cleaning elements are fiber bristles extending through said wire.

34. The toothbrush of claim 32 wherein said head has a back side opposite said cleaning surface, a shield being mounted to said back side across said open area outwardly beyond said cleaning elements, and said shield being of open construction to permit water and residue to flow through said shield.

35. The toothbrush of claim 32 wherein said shaft is power driven.

36. The toothbrush of claim 35 including two of said shafts being in roller form and being power driven.

37. The toothbrush of claim 35 wherein there are three of said shafts each of which is power driven.

38. The toothbrush of claim 32 wherein said cleaning elements are fiber bristles.

39. The toothbrush of claim 32 wherein said cleaning elements are elastomeric pads.

40. The toothbrush of claim 32 wherein said shaft is an injection molded core, and said cleaning elements being integral soft spikes.

41. The toothbrush of claim 40 wherein said spikes are made of an elastomer material which is softer than the elastomer material of said core.
